(19) United States
(12) Patent Application Publication
(10) Pub. No.: US 2024/0001797 A1
(43) Pub. Date: Jan. 4, 2024

(54) POWER SUPPLY FOR ELECTRIC VEHICLES

(71) Applicants: HYUNDAI MOTOR COMPANY, Seoul (KR); KIA CORPORATION, Seoul (KR)

(72) Inventors: Jong Wook Lee, Cheonan-si (KR); Hyun Jin Park, Hwaseong-si (KR)

(73) Assignees: HYUNDAI MOTOR COMPANY, Seoul (KR); KIA CORPORATION, Seoul (KR)

(21) Appl. No.: 17/988,387

(22) Filed: Nov. 16, 2022

(30) Foreign Application Priority Data
Jun. 30, 2022 (KR) 10-2022-0080675

(51) Int. Cl. B60L 53/80; H02J 7/00; H02J 9/00; H01M 50/209; H01M 50/249; H01M 50/256; H01M 50/271; H01M 50/262; B60L 53/22; B60L 50/60

(52) U.S. Cl. CPC B60L 53/80; H02J 7/0045; H02J 9/00; H02J 7/0063; H01M 50/209; H01M 50/249; H01M 50/256; H01M 50/271; H01M 50/262; B60L 53/22; B60L 50/66; H02J 2207/20; H01M 2220/20

(57) ABSTRACT

A power supply for electric vehicles includes: a main battery mounted to a vehicle to supply electric power to a motor generating a driving power for the vehicle; a supplementary battery charged with electric power to be supplied to the main battery; a battery rack provided in a vehicle body to load the supplementary battery; and a power converter configured to convert electricity power of the supplementary battery mounted to the battery rack to charge the main battery.

### CROSS REFERENCE TO RELATED APPLICATION

The present application claims priority to Korean Patent Application No. 10-2022-0080675, filed on Jun. 30, 2022, the entire contents of which is incorporated herein for all purposes by this reference.

### BACKGROUND

### Field of the Disclosure

The present disclosure relates to a power supply for electric vehicles.

### Description of the Related Art

An electric vehicle is configured to run using the power of a motor driven by electricity. A power supply is essentially mounted to an electric vehicle to supply electricity supplied to the motor.

In many cases, a conventional power supply for electric vehicles is composed of a high voltage battery (herein, referred to as ‘battery’) mounted to the vehicle.

There is a limit to the capacity of the above-described battery. The battery takes a relatively long time to charge, causing inconvenience to the user of the electric vehicle.

Therefore, a single charge should provide a relatively long driving distance for electric vehicles and minimal dwell time for charging.

The foregoing is intended merely to aid in understanding the background of the present disclosure. The foregoing is not intended to mean that the present disclosure falls within the purview of the related art already known to those ordinarily skilled in the art.

### SUMMARY

The present disclosure is intended to provide a power supply for electric vehicles. The power supply is configured to relatively and easily increase a cruising distance of an electric vehicle and to allow the vehicle to be quickly driven even when a relatively long time is required for charging of the main battery so as to significantly improve the convenience of use of the electric vehicle.

In order to achieve the above objective, according to one aspect of the present disclosure, a power supply is provided for electric vehicles. The power supply includes: a main battery mounted to a vehicle so as to supply electric power to a motor generating a driving power of the vehicle; a supplementary battery charged with electric power to be supplied to the main battery; a battery rack provided in a vehicle body so as to load the supplementary battery; and a power converter configured to convert electricity power of the supplementary battery mounted to the battery rack to charge the main battery.

The battery rack may have a plurality of battery insertion grooves into which a plurality of supplementary batteries may be inserted. Thus, the plurality of supplementary batteries may be inserted into plurality of battery insertion grooves and loaded to the battery rack.

Each of the supplementary batteries may be formed in a cuboid shape. Each of the supplementary batteries may include a handle on one surface thereof for a user. A guide groove may be formed on a location of a side surface perpendicular to the surface with the handle, the location being off-set from a center line of the side surface toward one side. The guide groove may guide a path along which the supplementary battery may be inserted into the battery rack.

A guide rail may be formed in each of the plurality of battery insertion grooves of the battery rack and the guide rail may be inserted into the guide groove of each of the supplementary batteries.

The plurality of battery insertion grooves into which the plurality of supplementary batteries may be inserted may be arranged on one side surface of the battery rack.

The plurality of battery insertion grooves may be arranged on the one side surface of the battery rack with a grid pattern.

Each of the plurality of battery insertion grooves of the battery rack may be sealed at an opening thereof by a battery cover after each of the plurality of supplementary batteries is inserted thereinto. A locking device may be provided between the battery cover and the battery rack so that the battery cover may keep a battery rack-mounted state constant.

The battery cover may include a compression spring configured to supply an elastic force in a direction in which the plurality of supplementary batteries may be inserted into the plurality of battery insertion grooves.

The handle may be configured to be in close contact with the supplementary battery when the user does not pull the handle.

The power converter may include a plurality of converters arranged in parallel to each other so as to be connected to the respective battery insertion grooves of the battery rack.

A power supply for electric vehicles may include a main battery provided in a vehicle body, a plurality of power converters connected to the main battery, and a battery rack to which the plurality of power converters may be connected. The battery rack may be configured to load a plurality of supplementary batteries therein.

The battery rack may include a plurality of battery insertion grooves to allow insertion of a plurality of supplementary batteries.

The power converters may be respectively connected to the supplementary batteries, which may be inserted into the respective battery insertion grooves of the battery rack.

Between each of the supplementary batteries and each of the battery insertion grooves of the battery rack, a guide structure may be provided to guide insertion of the supplementary battery into the battery insertion groove.

The guide structure may include a guide rail formed along an insertion direction of the supplementary battery and a guide groove into which the guide rail may be inserted, respectively.

Each of the plurality of battery insertion grooves of the battery rack may include a battery cover mounted by a locking device. The battery cover may be configured to close an opening through which each of the supplementary batteries may be inserted.

A compression spring may be provided in the battery cover to compress the supplementary battery.

The present disclosure provides an electric vehicle power supply that is configured to relatively and easily increase a cruising distance of the electric vehicle and to allow the vehicle to run quickly even when a relatively long time is required for charging of the main battery. Thus, the convenience of use of the electric vehicle can be significantly improved.

### BRIEF DESCRIPTION OF THE DRAWINGS

FIG. 1 is a view showing a power supply for electric vehicles according to the present disclosure;

FIG. 2 is a view showing a supplementary battery according to the present disclosure;

FIG. 3 is a view showing a state in which the supplementary battery is inserted into a battery rack;

FIG. 4 is a sectional view showing line IV-IV of FIG. 3;

FIG. 5 is a view showing a state in which the supplementary battery is completely loaded to the battery rack; and

FIGS. 6 and 7 are views respectively showing a locking device that may be used for the present disclosure.

### DETAILED DESCRIPTION

Hereinbelow, embodiments described in the specification are described in detail with reference to the accompanying drawings. Regardless of the reference numerals, the same reference numerals refer to the same or like parts and redundant descriptions thereof have been omitted.

The suffixes “module” and “part” for the components used in the following description are given or mixed in consideration of only the ease of description in the specification, and do not have distinct meanings or roles by themselves.

In the following description, where the detailed description of known functions or configurations related to the disclosure makes the subject matter of the disclosure unclear, the detailed description of such functions or configurations has been omitted.

Furthermore, the accompanying drawings are only for understanding the embodiments of the present disclosure. The technical ideas disclosed in the specification are not limited by the accompanying drawings. Those having ordinary skill in the art should appreciate that various modifications, additions, and substitutions are possible, without departing from the scope and spirit of the technical concepts as disclosed in the accompanying claims.

It should be understood that, although the terms first and/or second, and the like may be used herein to describe various elements, these elements should not be limited by these terms. These terms are only used to distinguish one element from another element.

It should be understood that when one element is referred to as being “connected to” or “coupled to” another element, the one element may be connected directly to or coupled directly to the other element or be connected to or coupled to the other element having one or more other elements intervening therebetween.

On the other hand, it should be understood that when one element is referred to as being “connected directly to” or “coupled directly to” another element, the one element may be connected to or coupled to the other element without any other element intervening therebetween.

Singular forms are intended to include plural forms unless the context clearly indicates otherwise. When a part, device, component, unit, module, or the like of the present disclosure is described as having a purpose or performing an operation, function, or the like, the part, device, component, unit, module, or the like should be considered herein as being “configured to” meet that purpose or to perform that operation or function.

It should be further understood that the terms “include”, “includes”, “comprise”, “comprises”, “has”, “have”, or the like used in this specification specify the presence of stated features, steps, operations, components, parts, or a combination thereof. Such terms do not preclude the presence or addition of one or more other features, numerals, steps, operations, components, parts, or a combination thereof.

Furthermore, a unit or a control unit included in names such as a motor control unit (MCU), a hybrid control unit (HCU), and the like is only a widely used term for a controller that controls a specific function of a vehicle and does not mean a generic function unit.

The controller may include a communication device communicating with other controllers or a sensor to control the function in charge. The controller may also include a memory storing an operation system or a logic command and input/output information. The controller may further include at least one process performing determination, calculation, and decision necessary for controlling the function in charge.

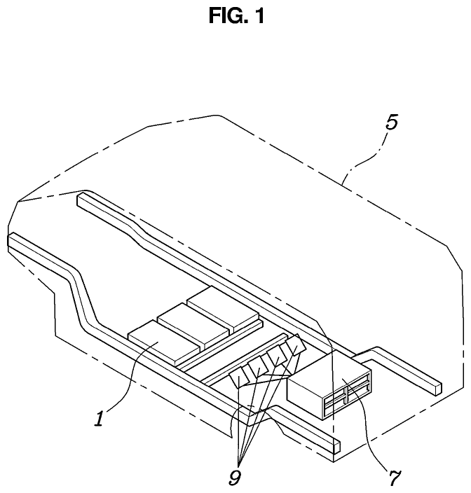

Referring to FIGS. 1-5, according to an embodiment of the present disclosure, the power supply for electric vehicles includes a main battery 1 loaded to a vehicle so as to supply electric power to a motor generating a driving force of the vehicle. The power supply also includes supplementary batteries 3 charged with electric power to be supplied to the main battery 1, a battery rack 7 provided in a vehicle body 5 so as to load the supplementary batteries 3, and power converters 9 configured to convert electric power of the supplementary batteries 3 mounted to the battery rack 7 to charge the main battery 1.

In other words, the power supply of the present disclosure is fundamentally configured to allow an electric vehicle to run by electric power of the main battery 1. However, in case of a power shortage of the main battery 1, the disclosed power supply is configured to transmit electric power of the supplementary batteries 3 to the main battery 1 to increase a cruising distance of the vehicle or is configured to allow the vehicle to continue to run without stopping the vehicle for charging the main battery 1. Thus, the availability of the electric vehicle is ultimately maximized.

The battery rack 7 may include a plurality of battery insertion grooves 11 into which the plurality of supplementary batteries 3 is inserted. Thus, the plurality of supplementary batteries 3 may be inserted into and loaded to the battery rack.

In other words, the battery rack 7 serves to allow the supplementary batteries 3 to be stably loaded on and separated from the vehicle body 5. The battery rack 7 may be configured to load only one supplementary battery 3 or configured to load the plurality of supplementary batteries 3. Therefore, it is possible to use the supplementary batteries 3 in various combinations, thereby improving the degree of freedom in supplementary battery operation and further improving an increase of the cruising distance of the vehicle.

In the embodiment, the plurality of battery insertion grooves 11 is arranged on one side surface of the battery rack 7 with a grid pattern.

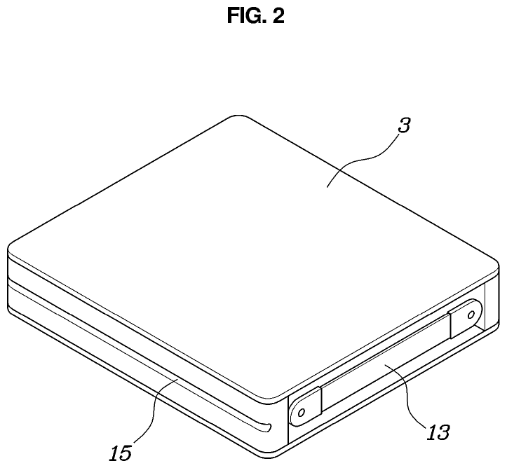

In the embodiment, as shown in FIG. 2, each of the supplementary batteries 3 has a cuboid shape and includes a handle 13 on one side surface for a user. Therefore, when the user takes each of the supplementary batteries 3 out of the battery rack 7 and charges the supplementary batteries outside the vehicle and when the user loads each of the fully charged supplementary batteries 3 into the battery rack 7, the handle 13 allows the user to easily handle each of the supplementary batteries 3.

As shown in FIG. 2, the handle 13 is formed as a pull-down handle in close contact with the supplementary battery 3 when the user does not pull the handle 13. Thus, the supplementary battery 3 does not occupy unnecessary space due to the handle 13 while being inserted in the battery rack 7. The energy density between the supplementary battery 3 and the battery rack 7 may be ultimately improved.

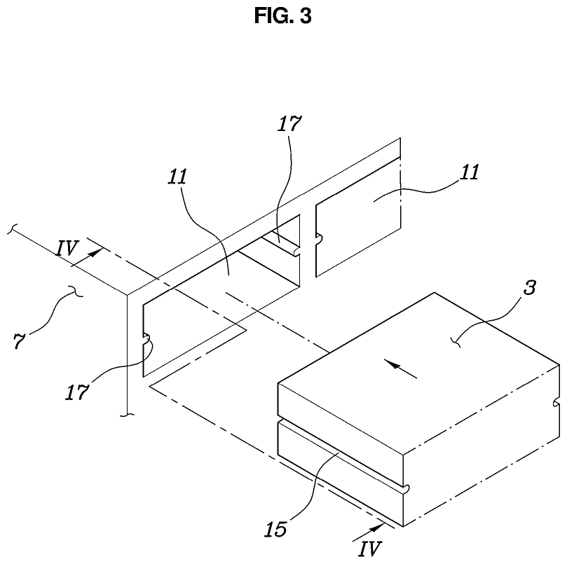

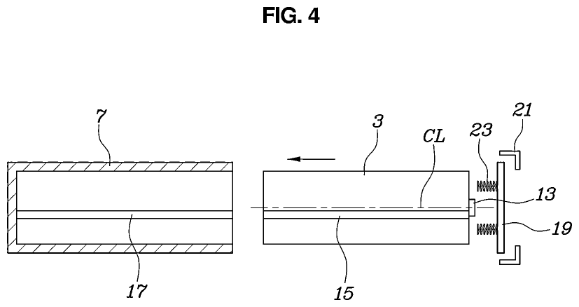

Furthermore, as shown in FIGS. 3 and 4, a guide groove 15 is formed on a location of a side surface perpendicular to the surface with the handle 13 of each of the supplementary batteries 3. The guide groove is located to be off-set from a center line CL of the surface in a one-sided direction to guide a path of the supplementary battery 3 inserted into the battery rack 7. Each of the battery insertion grooves 11 of the battery rack 7 includes a guide rail 17 inserted into the guide groove 15 of each of the supplementary batteries 3.

Therefore, each of the supplementary batteries 3 is not inserted into each of the battery insertion grooves 11 in an overturned or incorrectly oriented state and is instead inserted into each of the battery insertion grooves 11 only in a vertically correct direction or orientation state. Therefore, when the supplementary battery 3 is inserted into the battery rack 7, it is possible to exclude the possibility of disassembly.

Of course, the guide groove 15 and the guide rail 17 may be inversely located such that the guide groove is formed in the battery rack 7 and the guide rail is formed in each of the supplementary batteries 3.

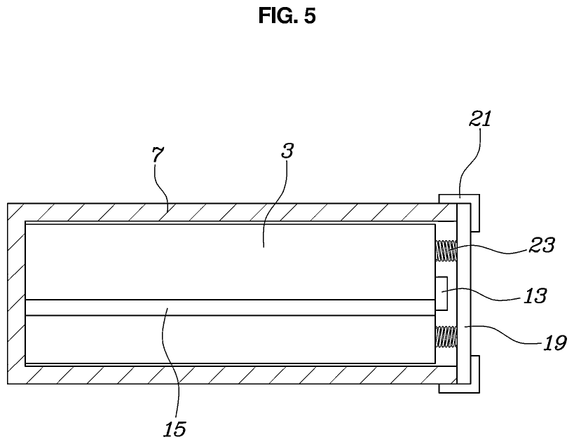

Each of the battery insertion grooves 11 of the battery rack 7 is sealed with a battery cover 19 after each of the supplementary batteries 3 is inserted, as shown in FIG. 5. A locking device 21 is provided between the battery cover 19 and the battery rack 7 to maintain a state in which the battery cover 19 is mounted to the battery rack 7 constant.

Furthermore, the compression spring 23 is provided on the battery cover 19 to supply an elastic force in a direction in which each of the supplementary batteries 3 is inserted into each of the battery insertion grooves 11.

Therefore, the inserted state of the supplementary battery 3 inserted into the battery insertion groove 11 may be stably secured and maintained by the elastic force of the compression spring 23.

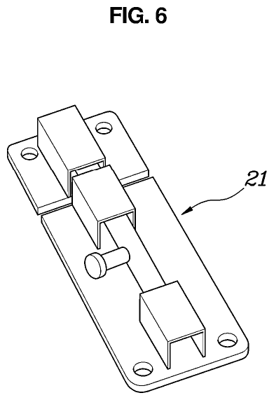

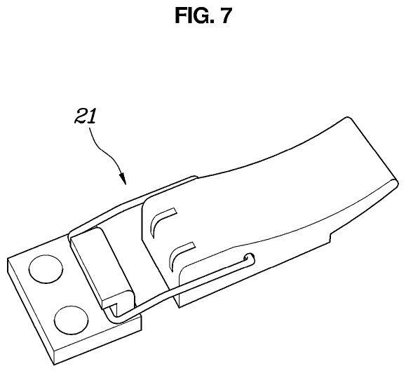

Devices as shown in FIGS. 6 and 7 may be used as the locking device 21. Other locking devices 21 having the shape of which the battery cover 19 is separated from and securely coupled to the battery rack 7 may be used as the locking device 21.

For reference, FIGS. 4 and 5 symbolically show the shape of the locking device 21.

A plurality of power converters 9 is provided in parallel so as to be connected to each of the battery insertion grooves 11 of the battery rack 7.

Therefore, when any one of the supplementary batteries 3 is loaded in any one of the battery insertion grooves 11 of the battery rack 7, one of the power converters 9 connected to the battery insertion groove 11 in which the supplementary battery 3 is loaded is operated so as to charge the main battery 1. This operation may be separately performed in the plurality of power converters 9 at the same time when the plurality of supplementary batteries 3 are loaded into the battery rack 7.

The details and advantages of the present disclosure described above are described as follows.

The power supply for electric vehicles of the present disclosure includes: the main battery 1 provided in the vehicle body 5; the plurality of power converters 9 connected to the main battery 1; and the battery rack 7 connected to the plurality of power converters 9 and formed to load the plurality of supplementary batteries 3.

The battery rack 7 may have the plurality of battery insertion grooves 11 into which the supplementary batteries 3 may be inserted.

The power converters 9 may be installed to be respectively connected to the supplementary batteries 3 inserted into the battery insertion grooves 11 through the battery insertion grooves 11 of the battery rack 7.

The guide structure may be provided between the supplementary batteries 3 and the battery insertion grooves 11 of the battery rack 7 to guide insertion of the supplementary batteries 3 into the battery insertion grooves 11.

The guide structure may include the guide rail 17 formed in the insertion direction of the supplementary batteries 3 and the guide groove 15 inserted into the guide rail 17.

The battery cover 19 may be installed at each of the battery insertion grooves 11 of the battery rack 7 by the locking device 21. The battery cover 19 may close the opening of each of the battery insertion grooves 11 into which each of the supplementary batteries 3 is inserted.

The compression spring 23 may be provided at an inside portion of the battery cover 19 to compress each of the supplementary batteries 3.

Although features of the inventive concepts of the present disclosure have been disclosed in detail only with respect to the above specific embodiments, those having ordinary skill in the art should appreciate that various modifications, additions, and substitutions are possible, without departing from the spirit and scope of the present disclosure. It is appropriate that the various modifications, additions, and substitutions are included in the scope of the accompanying claims.

What is claimed is:

1. A power supply for electric vehicles, the power supply comprising:
a main battery mounted to a vehicle so as to supply electric power to a motor generating a driving power of the vehicle;
a supplementary battery charged with electric power to be supplied to the main battery;
a battery rack provided in a vehicle body so as to load the supplementary battery; and
a power converter configured to convert electric power of the supplementary battery mounted to the battery rack to charge the main battery.

2. The power supply of claim 1, wherein the battery rack has a plurality of battery insertion grooves configured to receive therein a plurality of supplementary batteries, so that the plurality of supplementary batteries is inserted into the plurality of battery insertion grooves and loaded to the battery rack.

3. The power supply of claim 2, wherein
each of the supplementary batteries is formed in a cuboid shape;
each of the supplementary batteries includes a handle on one surface thereof for a user; and
each of the supplementary batteries includes a guide groove is formed on a location of a side surface perpendicular to the surface with the handle, the location being off-set from a center line of the side surface toward one side, and the guide groove guides a path along which the supplementary battery is inserted into the battery rack.

4. The power supply of claim 3, wherein a guide rail is formed in each of the plurality of battery insertion grooves of the battery rack and each guide rail is inserted into a respective one of the guide grooves of each of the supplementary batteries.

5. The power supply of claim 3, wherein the plurality of battery insertion grooves into which the plurality of supplementary batteries is inserted is arranged on one side surface of the battery rack.

6. The power supply of claim 5, wherein the plurality of battery insertion grooves is arranged on the one side surface of the battery rack with a grid pattern.

7. The power supply of claim 3, wherein each of the plurality of battery insertion grooves of the battery rack is sealed at an opening thereof by a battery cover after each of the plurality of supplementary batteries is inserted thereinto; and
a locking device is provided between the battery cover and the battery rack so that the battery cover keeps a battery rack-mounted state constant.

8. The power supply of claim 7, wherein the battery cover comprises a compression spring configured to supply an elastic force in a direction in which the plurality of supplementary batteries is inserted into the plurality of battery insertion grooves.

9. The power supply of claim 3, wherein the handle is configured to be in close contact with the supplementary battery when the user does not pull the handle.

10. The power supply of claim 2, wherein the power converter comprises a plurality of converters arranged in parallel to each other so as to be connected to the respective battery insertion grooves of the battery rack.

11. A power supply for electric vehicles, the power supply comprising:
a main battery provided in a vehicle body;
a plurality of power converters connected to the main battery; and
a battery rack to which the plurality of power converters is connected, the battery rack configured to load a plurality of supplementary batteries therein.

12. The power supply of claim 11, wherein the battery rack comprises a plurality of battery insertion grooves to allow plurality of supplementary batteries to be inserted thereinto.

13. The power supply of claim 12, wherein the power converters are respectively connected to the supplementary batteries inserted into the battery insertion grooves through the respective battery insertion grooves of the battery rack.

14. The power supply of claim 13, wherein, between each of the supplementary batteries and each of the battery insertion grooves of the battery rack, a guide structure is provided to guide insertion of the supplementary battery into the battery insertion groove.

15. The power supply of claim 14, wherein the guide structure comprises a guide rail formed along an insertion direction of the supplementary battery and a guide groove into which the guide rail is inserted, respectively.

16. The power supply of claim 11, wherein each of the plurality of battery insertion grooves of the battery rack comprises a battery cover mounted by a locking device, and wherein the battery cover is configured to close an opening through which each of the supplementary batteries is inserted.

17. The power supply of claim 16, wherein a compression spring is provided in the battery cover to compress the supplementary battery.
